(19) United States
(12) Patent Application Publication
(10) Pub. No.: US 2026/0275436 A1
(43) Pub. Date: Sep. 17, 2026

(54) METHODS AND SYSTEMS FOR LOW-SLAG EFFICIENT SMELTING BASED ON SUBMERGED SUPERSONIC GAS-SOLID INJECTION

(71) Applicant: UNIVERSITY OF SCIENCE AND TECHNOLOGY BEIJING, Beijing (CN)

(72) Inventors: Guangsheng WEI, Beijing (CN); Ceng LI, Beijing (CN); Rong ZHU, Beijing (CN); Shufeng YANG, Beijing (CN); Chao FENG, Beijing (CN); Fuhai LIU, Beijing (CN); Chengjin HAN, Beijing (CN); Hongbin WANG, Beijing (CN); Runzhe WANG, Beijing (CN)

(73) Assignee: UNIVERSITY OF SCIENCE AND TECHNOLOGY BEIJING, Beijing (CN)

(21) Appl. No.: 19/375,173

(22) Filed: Oct. 30, 2025

Related U.S. Application Data
(63) Continuation of application No. PCT/CN2025/102993, filed on Jun. 24, 2025.

(30) Foreign Application Priority Data
Mar. 14, 2025 (CN) 202510305746.1

(51) Int. Cl. C21C 5/34

(52) U.S. Cl. CPC C21C 5/34

(57) ABSTRACT

Provided are methods and systems for low-slag efficient smelting based on submerged supersonic gas-solid injection. The method includes: in a raw material charging period, controlling a submerged supersonic gas-solid oxygen lance in a protective gas mode; in a melting period, changing the submerged supersonic gas-solid oxygen lance to an oxygen supply mode and then a gas-solid injection mode; in an oxidation and temperature-rising period, and in an early stage, maintaining the flow rate of the slag-forming material at 50-200 kg/min; in a late stage, controlling the flow rate of the slag-forming material to be not greater than 50 kg/min; after completion of slagging and dephosphorization, changing the submerged supersonic gas-solid oxygen lance to a gas supply mode; in a tapping stage, controlling the submerged supersonic gas-solid oxygen lance to stop oxygen supply and start the protective gas mode, completing smelting of the molten steel, and performing tapping.

### CROSS-REFERENCE TO RELATED APPLICATIONS

This application is a Continuation of International Application No. PCT/CN2025/102993, filed on Jun. 24, 2025, which claims priority to Chinese Patent Application No. 202510305746.1, filed on Mar. 14, 2025, the entire contents of each of which are hereby incorporated by reference.

### TECHNICAL FIELD

The present disclosure relates to the technical field of steel smelting technology, and in particular, to a method and a system for low-slag efficient smelting based on submerged supersonic gas-solid injection.

### BACKGROUND

Dephosphorization constitutes a critical objective in a steelmaking process. The key to low-slag and efficient dephosphorization lies in controlling the early stage temperature of a molten bath, the slag-forming rate, and the utilization efficiency of lime, while also ensuring favorable kinetic conditions. With the increase in oxygen supply intensity and the emergence of bottom-blowing stirring technology, the pace of steelmaking has accelerated. How to rapidly form slag, reduce the slag volume, and achieve efficient dephosphorization has become one of the critical issues in steelmaking.

Currently, the slag-forming material in steelmaking primarily relies on CaO-based slagging agents. These are typically added in lump form from the top charging bin of the furnace. The oxides need to gradually penetrate the lime lump from the surface to the core to complete the slagging process and react with CaO at a high temperature to form low-melting-point compounds. To enhance the melting speed of the slag-forming material, methods such as adding a certain amount of slagging flux and intensifying stirring (bottom blowing or top blowing) are commonly employed to accelerate the dissolution of lime. However, it is still difficult to meet the requirements for rapid slag formation and dephosphorization.

Therefore, it is desirable to provide a method and a system for low-slag efficient smelting based on the submerged supersonic gas-solid injection to achieve rapid slag formation, reduce the slag volume, and improve dephosphorization efficiency, thereby meeting the requirements for low-slag and efficient dephosphorization in the steelmaking process.

### SUMMARY

One or more embodiments of the present disclosure provide a method for low-slag efficient smelting based on submerged supersonic gas-solid injection. The method may include: in a raw material charging period, and in a scrap steel and molten iron charging stage, controlling a submerged supersonic gas-solid oxygen lance in a protective gas mode, wherein a protective gas flow rate is 10-200 m³/h; in a melting period, in response to determining that charging of raw material is completed, changing the submerged supersonic gas-solid oxygen lance to an oxygen supply mode, wherein the submerged supersonic gas-solid oxygen lance is extended into a slag layer, and an oxygen flow rate is 600-3000 m³/h; in response to determining that the oxygen flow rate reaches a preset value, changing the submerged supersonic gas-solid oxygen lance to a gas-solid injection mode, wherein an outlet of the submerged supersonic gas-solid oxygen lance includes, from inside to outside, a gas-solid channel, a first annular oxygen channel, an annular combustion channel, and a second annular oxygen channel, a flow rate of slag-forming material of the gas-solid channel is 30-200 kg/min, the oxygen flow rate is 600-3000 m³/h, the oxygen flow rate of the first annular oxygen channel is 10-200 m³/h, a methane flow rate of the annular combustion channel is 20-400 m³/h, and the oxygen flow rate of the second annular oxygen channel is 10-200 m³/h; in an oxidation and temperature-rising period, and in an early stage of oxidation and temperature rising, maintaining the flow rate of the slag-forming material at 50-200 kg/min; in a late stage of oxidation and temperature rising, controlling the flow rate of the slag-forming material to be not greater than 50 kg/min; after completion of slagging and dephosphorization, changing the submerged supersonic gas-solid oxygen lance to a gas supply mode, wherein the oxygen flow rate is 1500-2500 m³/h; in a tapping stage, in response to determining that a temperature of molten steel rises to an expected temperature, controlling the submerged supersonic gas-solid oxygen lance to stop oxygen supply and start the protective gas mode, completing smelting of the molten steel, and performing tapping.

Compared with the prior arts, the beneficial effects of the present disclosure include:

The method and the system for low-slag efficient smelting based on the submerged supersonic gas-solid injection provided by the present disclosure are used to solve problems in traditional electric arc furnace steelmaking processes, such as slow slag formation, large slag volume, and low dephosphorization rate due to insufficient stirring during the dephosphorization period. By using a submerged supersonic gas-solid oxygen lance device in an electric arc furnace to inject the slag-forming material (e.g., lime powder) to a steel-slag interface and increasing the jet impact on the molten bath, the slag-forming material may be fully in contact with the molten bath, thereby enhancing stirring of the molten bath, improving thermodynamic and kinetic conditions of the dephosphorization reaction, realizing low-slag and efficient dephosphorization during the smelting process, which is beneficial for improving the dephosphorization rate in the electric arc furnace steelmaking and reducing consumption of the slag-forming material and iron loss during the steelmaking process. The method for low-slag and efficient dephosphorization for the electric arc furnace based on the submerged supersonic gas-solid injection achieves low-slag and efficient dephosphorization in the electric arc furnace by controlling an injection volume of the slag-forming material in stages, dividing the electric arc furnace smelting process according to dephosphorization requirements and smelting characteristics of different periods, and allocating the injection volume of the slag-forming material on demand.

The solution provided by the present disclosure is applicable to 50-150 t electric arc furnace dephosphorization processes. Compared with traditional electric arc furnace steelmaking processes, the present disclosure improves dephosphorization efficiency by about 2.5-5%, reduces a slag volume by 5-20 kg/t, reduces consumption of the slag-forming material by about 5%-10%, and increases a metal yield by over 0.5%.

### BRIEF DESCRIPTION OF THE DRAWINGS

In order to more clearly illustrate the technical solutions of the embodiments of the present disclosure, the accompanying drawings to be used in the embodiments will be briefly described below, and it should be understood that the following accompanying drawings illustrate only certain embodiments of the present disclosure, and therefore should not be regarded as limiting the scope of the present disclosure.

FIG. 1 is an exemplary schematic diagram of a system for low-slag efficient smelting based on submerged supersonic gas-solid injection according to some embodiments of the present disclosure;

FIG. 2 is an exemplary schematic diagram illustrating a structure of a submerged supersonic gas-solid oxygen lance according to some embodiments of the present disclosure; and

FIG. 3 is an exemplary flowchart of a process for low-slag efficient smelting based on the submerged supersonic gas-solid injection according to some embodiments of the present disclosure.

Reference signs: 1—electric arc furnace; 2—powder injection tank; 3—submerged supersonic gas-solid oxygen lance; 4—control device; 31—gas-solid channel; 32—first annular oxygen channel; 33—annular combustion channel; 34—second annular oxygen channel.

### DETAILED DESCRIPTION

The embodiments of the present disclosure are described in detail below with reference to the examples. A person skilled in the art will understand that the following examples are only used to illustrate the present disclosure and should not be construed as limiting the scope of the present disclosure. For those without specified conditions in the examples, operations are performed under conventional conditions or conditions recommended by the manufacturer. Reagents or instruments without specified manufacturers are conventional products that can be obtained commercially.

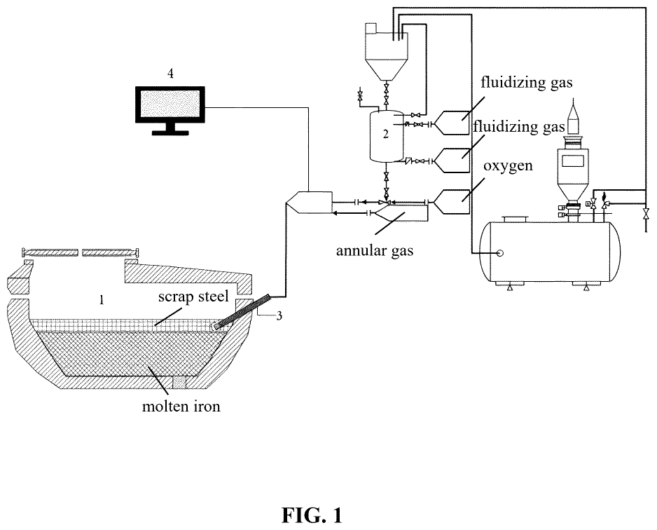

FIG. 1 is an exemplary schematic diagram of a system for a method for low-slag efficient smelting based on submerged supersonic gas-solid injection according to some embodiments of the present disclosure.

In some embodiments, the system for the method for low-slag efficient smelting based on submerged supersonic gas-solid injection may include an electric arc furnace 1, a powder injection tank 2, a submerged supersonic gas-solid oxygen lance 3, and a control device 4. A movable submerged supersonic gas-solid oxygen lance 3 is arranged on a furnace wall of the electric arc furnace 1. The submerged supersonic gas-solid oxygen lance 3 is connected to the powder injection tank 2 via a pipeline. The control device 4 is connected to the electric arc furnace 1, the powder injection tank 2, and the submerged supersonic gas-solid oxygen lance 3 in a wired or wireless manner.

The electric arc furnace 1 refers to a device for smelting steel. Merely by way of example, the electric arc furnace may include a roof-swiveling AC electric arc furnace (AC EAF), a furnace-body-tilting DC electric arc furnace (DC EAF), and a continuous charging/shaft electric arc furnace (Consteel, EcoArc, etc.).

In some embodiments, the submerged supersonic gas-solid oxygen lance 3 may be arranged on the electric arc furnace 1. The electric arc furnace 1 is in communication with the control device 4.

The powder injection tank 2 refers to a device for conveying slag-forming material. Merely by way of example, the powder injection tank 2 may be a fluidized bed powder injection tank. The slag-forming material may include one or more of quicklime powder, limestone powder, fluorite powder, and magnesium ball powder.

In some embodiments, a fluidizing gas (e.g., air, nitrogen) is delivered into the powder injection tank 2 to form a uniform fluidized layer of the slag-forming material in the powder injection tank 2, allowing the slag-forming material to fall by gravity to a powder outlet of the powder injection tank 2.

In some embodiments, the powder injection tank 2 may be configured to deliver the slag-forming material to the submerged supersonic gas-solid oxygen lance 3.

The submerged supersonic gas-solid oxygen lance 3 refers to a device for delivering the slag-forming material, methane, oxygen, and a protective gas to the electric arc furnace 1. The protective gas may include nitrogen and/or carbon dioxide.

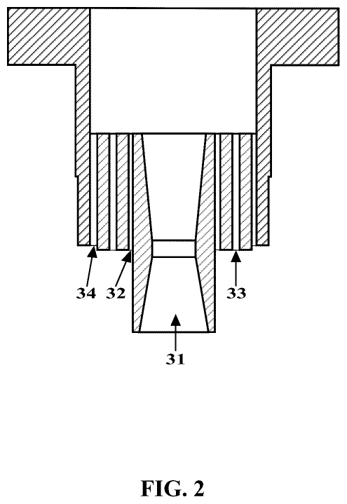

FIG. 2 is an exemplary schematic diagram illustrating a structure of a submerged supersonic gas-solid oxygen lance according to some embodiments of the present disclosure.

In some embodiments, an outlet of the submerged supersonic gas-solid oxygen lance 3 may include, from inside to outside, a gas-solid channel 31, a first annular oxygen channel 32, an annular combustion channel 33, and a second annular oxygen channel 34.

In some embodiments, the submerged supersonic gas-solid oxygen lance 3 may deliver the slag-forming material via the gas-solid channel 31, deliver oxygen via the gas-solid channel 31, the first annular oxygen channel 32, and the second annular oxygen channel 34, deliver the methane via the annular combustion channel 33, and deliver the protective gas via the first annular oxygen channel and the second annular oxygen channel.

The gas-solid channel 31 refers to a channel in the submerged supersonic gas-solid oxygen lance 3 for delivering slag-forming material.

The first annular oxygen channel 32 refers to a channel in the submerged supersonic gas-solid oxygen lance 3 for preventing backflow of molten slag.

In some embodiments, the first annular oxygen channel 32 may blow oxygen at a supersonic speed to form a relatively high-speed gas wall (e.g., a gas curtain) outside the gas-solid channel to prevent backflow of the molten slag into the submerged supersonic gas-solid oxygen lance 3.

In some embodiments, the first annular oxygen channel 32 may also provide an additional oxygen source to the slag-forming material to assist in dephosphorization and combustion.

The annular combustion channel 33 refers to a channel in the submerged supersonic gas-solid oxygen lance 3 for delivering a fuel gas. The fuel gas may be methane.

The second annular oxygen channel 34 refers to a channel in the submerged supersonic gas-solid oxygen lance 3 for delivering oxygen.

In some embodiments, the second annular oxygen channel 34 may blow oxygen at the supersonic speed to form the relatively high-speed gas wall (e.g., a gas curtain) outside the submerged supersonic gas-solid oxygen lance 3 to prevent backflow of the molten slag into the submerged supersonic gas-solid oxygen lance 3.

In some embodiments, the second annular oxygen channel 34 may also provide oxygen required for the complete combustion of the fuel gas delivered from the annular combustion channel 33.

Merely by way of example, a technician may transport the slag-forming material, such as lime powder, to the electric arc furnace smelting site by means of a tank truck or an intermediate tank. The slag-forming material, such as lime powder, is input into the gas-solid channel 31 of the submerged supersonic gas-solid oxygen lance 3 via the powder injection tank 2 and subjected to supersonic submerged injection, so that a gas and solid mixed jet directly impacts a steel-slag interface for rapid low-slag efficient dephosphorization.

The control device 4 refers to a device for controlling an injection mode of the submerged supersonic gas-solid oxygen lance 3.

In some embodiments, the control device may be a processor. Merely by way of example, the processor may include a central processing unit (CPU), an application-specific integrated circuit (ASIC), an application-specific instruction set processor (ASIP), a physics processing unit (PPU), a digital signal processor (DSP), a processor, a microprocessor unit, a reduced instruction set computer (RISC), a microprocessor, or the like, or any combination thereof. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an internal cloud, a multi-layer cloud, or the like, or any combination thereof.

In some embodiments, the control device opens a furnace cover of the electric arc furnace 1 and adds scrap steel and molten iron into the electric arc furnace 1. In response to determining that the furnace cover of the electric arc furnace 1 is closed and electrodes of the electric arc furnace 1 are energized, the control device 4 may control the submerged supersonic gas-solid oxygen lance 3 to a protective gas mode during a raw material charging period. The control device 4 adjusts the submerged supersonic gas-solid oxygen lance 3 to change to a gas-solid injection mode during a melting period and adjusts an injection flow rate of the slag-forming material by the submerged supersonic gas-solid oxygen lance 3 according to a situation. The control device 4 adjusts the submerged supersonic gas-solid oxygen lance 3 to change to a gas supply mode until a late stage of oxidation and temperature rising. The control device 4 adjusts the submerged supersonic gas-solid oxygen lance 3 to change to the protective gas mode during a tapping stage.

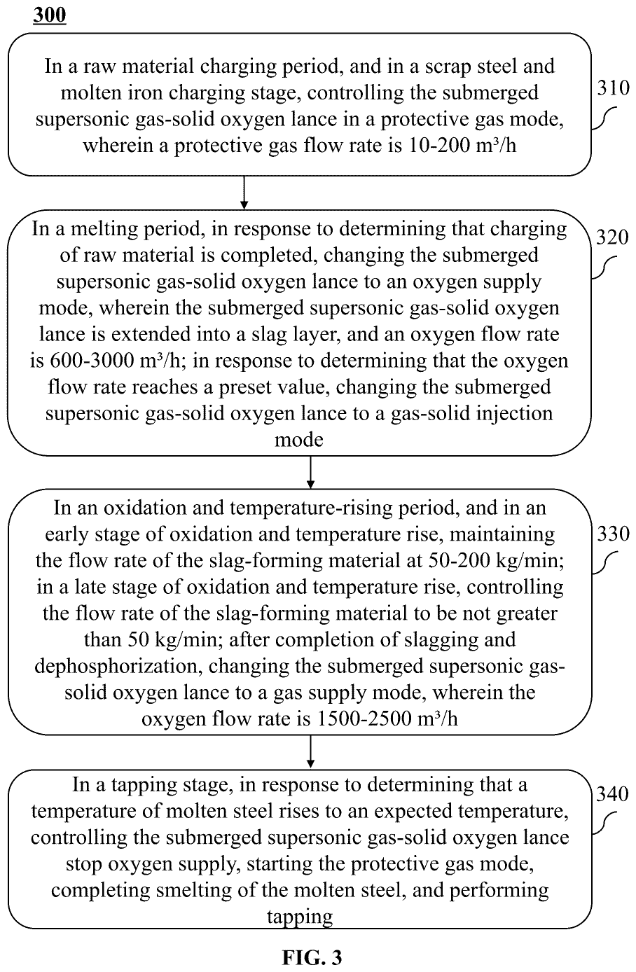

FIG. 3 is an exemplary flowchart of a process for low-slag efficient smelting based on submerged supersonic gas-solid injection according to some embodiments of the present disclosure. As shown in FIG. 3, a process 300 may includes step 310 to step 340. In some embodiments, the process 300 is executed by the control device.

In 310, in a raw material charging period, and in a scrap steel and molten iron charging stage, the submerged supersonic gas-solid oxygen lance may be in a protective gas mode, and a protective gas flow rate may be 10-200 m³/h. For more descriptions regarding the electric arc furnace and the submerged supersonic gas-solid oxygen lance, please refer to FIG. 1 and descriptions thereof.

The raw material charging period refers to a steelmaking stage in which a raw material is added at the beginning of steelmaking. The raw material may include scrap steel and molten iron. The scrap steel and molten iron charging stage refers to adding the scrap steel and the molten iron into the electric arc furnace.

In some embodiments, the raw material charging period may be preset by a technician based on experience.

The scrap steel refers to a recycled metal material that has undergone at least one smelting process.

The molten iron refers to liquid pig iron directly discharged from a device such as a blast furnace or a smelting reduction furnace.

Merely by way of example, the technician may control, via the control device, a top furnace cover of the electric arc furnace to open and control a bottom hydraulic door of the scrap steel charging basket to open, allowing the scrap steel to fall freely into the electric arc furnace. A charging hole exists in a side wall of the electric arc furnace. The charging hole is connected to a chute on an outer side wall of the electric arc furnace. The technician may control a tilting car to pour the molten iron into the chute, allowing the molten iron to enter the electric arc furnace through the chute and the charging hole.

The protective gas mode refers to a mode in which the submerged supersonic gas-solid oxygen lance blows a protective gas.

In some embodiments, the protective gas mode is configured to isolate air and prevent splashing of the raw material from blocking an outlet of the submerged supersonic gas-solid oxygen lance.

In some embodiments, in response to determining that the submerged supersonic gas-solid oxygen lance is in the protective gas mode, the protective gas flow rate ejected from the submerged supersonic gas-solid oxygen lance is 10-200 m³/h. The protective gas refers to a gas used to prevent splashing and blockage. For example, the protective gas may be nitrogen and/or carbon dioxide. The protective gas flow rate refers to a volume of the protective gas ejected from the submerged supersonic gas-solid oxygen lance per unit time.

In some embodiments, the protective gas flow rate includes 10 m³/h-29 m³/h, 29 m³/h-48 m³/h, 48 m³/h-67 m³/h, 67 m³/h-86 m³/h, 86 m³/h-105 m³/h, 105 m³/h-124 m³/h, 124 m³/h-143 m³/h, 143 m³/h-162 m³/h, 162 m³/h-181 m³/h, and 181 m³/h-200 m³/h. In some embodiments, the protective gas flow rate may be one or more of 10 m³/h, 29 m³/h, 48 m³/h, 67 m³/h, 86 m³/h, 105 m³/h, 124 m³/h, 143 m³/h, 162 m³/h, 181 m³/h, and 200 m³/h.

In some embodiments, the control device is configured to determine the protective gas flow rate by querying a first preset table based on a volume of the electric arc furnace and a diameter of the outlet of the submerged supersonic gas-solid oxygen lance. The first preset table includes a relationship between the volume of the electric arc furnace, the diameter of the outlet of the submerged supersonic gas-solid oxygen lance, and the protective gas flow rate. In some embodiments, the first preset table may be preset by a technician based on experience.

For example, if the volume of the electric arc furnace is 75 t and the diameter of the outlet of the submerged supersonic gas-solid oxygen lance is 50 mm, the protective gas flow rate is 30 m³/h.

In some embodiments, the protective gas includes nitrogen and/or carbon dioxide.

In some embodiments of the present disclosure, using nitrogen and/or carbon dioxide as the protective gas effectively blocks air intrusion, thus a secondary oxidation rate of the molten steel can be reduced, and an explosion risk caused by mixing carbon monoxide with air can be avoided.

In some embodiments, in response to determining that the steelmaking stage is the raw material charging period, the control device is configured to generate a protection mode change instruction and to control a mode of the submerged supersonic gas-solid oxygen lance to change to the protective gas mode based on the protection mode change instruction.

In 320, in a melting period, in response to determining that charging of raw material is completed, the submerged supersonic gas-solid oxygen lance may be changed to an oxygen supply mode. The submerged supersonic gas-solid oxygen lance may be extended into a slag layer, and an oxygen flow rate is 600-3000 m³/h. In response to determining that the oxygen flow rate reaches a preset value, the submerged supersonic gas-solid oxygen lance may be changed to a gas-solid injection mode.

The melting period refers to a steelmaking stage in which the electric arc furnace begins dephosphorization of the raw material.

In some embodiments, the control device is configured to determine whether the steelmaking stage has entered the melting period based on whether electrodes of the electric arc furnace are energized.

For example, in response to determining that a furnace mouth of the electric arc furnace is closed, raw material addition is stopped, and the electrodes of the electric arc furnace are energized, the control device is configured to determine that a current steelmaking stage is the melting period.

In some embodiments, the melting period includes an early melting stage and a late melting stage. In response to determining that a carbon content of the raw material is greater than a carbon content threshold and a surface of the scrap steel is visible, the current steelmaking stage is the early melting stage. In response to determining that the carbon content of the raw material is less than or equal to the carbon content threshold and the surface of the scrap steel is not visible, the current steelmaking stage is the late melting stage.

The carbon content threshold refers to a carbon content of the raw materials for determining whether the current steelmaking stage is the early melting stage or the late melting stage. For example, the carbon content threshold is 1%. In some embodiments, the carbon content threshold is preset by a technician based on experience.

In some embodiments, the control device is configured to determine the carbon content of the raw material in the electric arc furnace and whether the surface of the scrap steel is visible through various methods.

For example, the control device is configured to analyze a gas composition in exhaust gas discharged from the electric arc furnace via a chemical sensor (e.g., a gas analysis sensor) and determine the carbon content of the raw material in the electric arc furnace based on a ratio of carbon dioxide to carbon monoxide in the exhaust gas.

As another example, the control device is configured to determine whether the scrap steel in the electric arc furnace has melted below a liquid level of the molten iron via a scanning device (e.g., a laser scanner, a laser radar level gauge). If the scanning device scans the surface of the scrap steel above the liquid level of the molten iron, the surface of the scrap steel is determined to be visible. If the scanning device does not scan the surface of the scrap steel above the liquid level of the molten iron, the surface of the scrap steel is determined to be not visible.

Merely by way of example, in response to determining that the steelmaking stage is the early melting stage, the control device is configured to control the submerged supersonic gas-solid oxygen lance to inject the slag-forming material at a low flow rate (e.g., a flow rate of the slag-forming material of the gas-solid channel is 30 kg/min, an oxygen flow rate of the gas-solid channel is 1000 m³/h, an oxygen flow rate of the first annular oxygen channel is 50 m³/h, a methane flow rate of the annular combustion channel is 100 m³/h, an oxygen flow rate of the second annular oxygen channel is 50 m³/h) for rapid melting and slagging. In response to determining that the steelmaking stage is the late melting stage, the control device is configured to control the submerged supersonic gas-solid oxygen lance to perform deep dephosphorization via supersonic gas-solid injection at a high flow rate (e.g., the flow rate of the slag-forming material of the gas-solid channel is 40 kg/min, the oxygen flow rate of the gas-solid channel is 2000 m³/h, the oxygen flow rate of the first annular oxygen channel is 100 m³/h, the methane flow rate of the annular combustion channel is 200 m³/h, the oxygen flow rate of the second annular oxygen channel is 100 m³/h), while adding a portion of lumpy slag-forming material to accelerate metallurgical chemical reactions.

In some embodiments, the slag-forming material includes one or more of quicklime powder, limestone powder, fluorite powder, and magnesium ball powder.

In some embodiments of the present disclosure, the quicklime powder and the limestone powder provide a sufficient amount of calcium oxide and have stable basicity, which can improve dephosphorization efficiency when the slag-forming material impacts the slag layer. The fluorite powder may reduce a melting point of the scrap steel, facilitating mass transfer and slag removal. The magnesium ball powder saturates a magnesium oxide concentration in the slag layer, reducing lining corrosion.

In some embodiments, a particle size of the slag-forming material is 100-400 mesh.

In some embodiments, the particle size of the slag-forming material includes 100 mesh-130 mesh, 130 mesh-160 mesh, 160 mesh-190 mesh, 190 mesh-220 mesh, 220 mesh-250 mesh, 250 mesh-280 mesh, 280 mesh-310 mesh, 310 mesh-340 mesh, 340 mesh-370 mesh, and 370 mesh-400 mesh. In some embodiments, the particle size of the slag-forming material is one or more of 100 mesh, 130 mesh, 160 mesh, 190 mesh, 220 mesh, 250 mesh, 280 mesh, 310 mesh, 340 mesh, 370 mesh, and 400 mesh.

In some embodiments of the present disclosure, adjusting the particle size of the slag-forming material to 100-400 mesh reduces slag formation time, reduces arc exposure time, and lowers energy consumption.

In some embodiments, the lumpy slag-forming material is also added during the melting period and an oxidation and temperature-rising period.

Merely by way of example, a particle size of the lumpy slag-forming material includes 10 mm-20 mm, 20 mm-30 mm, and 30 mm-40 mm. The particle size of the lumpy slag-forming material may be one or more of 10 mm, 20 mm, 30 mm, and 40 mm.

In some embodiments of the present disclosure, the lumpy slag-forming material continuously releases calcium oxide at a bottom of the electric arc furnace, reacts synergistically with a powdered slag-forming material, which improves a utilization rate of calcium oxide, reduces thermal energy consumption during injection of the powdered slag-forming material, stabilizes arc power, and avoids deterioration of furnace conditions caused by accidental terminal interruption of the powdered slag-forming material.

In some embodiments, a carrier gas flow rate for the slag-forming material is 100-3000 m³/h. A carrier gas includes oxygen.

In some embodiments, the carrier gas flow rate includes 100 m³/h-390 m³/h, 390 m³/h-680 m³/h, 680 m³/h-970 m³/h, 970 m³/h-1260 m³/h, 1260 m³/h-1550 m³/h, 1550 m³/h-1840 m³/h, 1840 m³/h-2130 m³/h, 2130 m³/h-2420 m³/h, 2420 m³/h-2710 m³/h, and 2710 m³/h-3000 m³/h. In some embodiments, the carrier gas flow rate may be one or more of 100 m³/h, 390 m³/h, 680 m³/h, 970 m³/h, 1260 m³/h, 1550 m³/h, 1840 m³/h, 2130 m³/h, 2420 m³/h, 2710 m³/h, and 3000 m³/h.

In some embodiments of the present disclosure, by adjusting the carrier gas flow rate within 100-3000 m³/h, splashing during early-stage slagging can be avoided, and deep injection into a molten bath can be realized during a later stage, which enhances the dephosphorization effect.

The oxygen supply mode refers to a mode for supplying oxygen to the electric arc furnace to rapidly increase the temperature of the electric arc furnace.

In some embodiments, in response to determining that the submerged supersonic gas-solid oxygen lance is in the oxygen supply mode, the submerged supersonic gas-solid oxygen lance extends into the slag layer, and the oxygen flow rate is 600-3000 m³/h. The oxygen flow rate refers to a volume of oxygen ejected from the submerged supersonic gas-solid oxygen lance per unit time.

In some embodiments, the oxygen flow rate of the gas-solid channel includes 600 m³/h-840 m³/h, 840 m³/h-1080 m³/h, 1080 m³/h-1320 m³/h, 1320 m³/h-1560 m³/h, 1560 m³/h-1800 m³/h, 1800 m³/h-2040 m³/h, 2040 m³/h-2280 m³/h, 2280 m³/h-2520 m³/h, 2520 m³/h-2760 m³/h, and 2760 m³/h-3000 m³/h. In some embodiments, the oxygen flow rate is one or more of 600 m³/h, 840 m³/h, 1080 m³/h, 1320 m³/h, 1560 m³/h, 1800 m³/h, 2040 m³/h, 2280 m³/h, 2520 m³/h, 2760 m³/h, and 3000 m³/h.

In some embodiments, an oxygen pressure of the submerged supersonic gas-solid oxygen lance is 0.5-1.6 MPa.

In some embodiments, the oxygen pressure includes 0.5 MPa-0.72 MPa, 0.72 MPa-0.94 MPa, 0.94 MPa-1.16 MPa, 1.16 MPa-1.38 MPa, and 1.38 MPa-1.6 MPa. In some embodiments, the oxygen pressure is one or more of 0.5 MPa, 0.72 MPa, 0.94 MPa, 1.16 MPa, 1.38 MPa, and 1.6 MPa.

In some embodiments of the present disclosure, by setting the oxygen pressure of the submerged supersonic gas-solid oxygen lance to 0.5-1.6 MPa, supersonic injection of the submerged supersonic gas-solid oxygen lance can be stably achieved, which reduces thermal load and wear of a lance tip and increases the dephosphorization rate.

In some embodiments, in response to determining that a steelmaking stage is the melting period, a control device may generate an oxygen supply mode change instruction. The control device controls the mode of the submerged supersonic gas-solid oxygen lance to change to the oxygen supply mode based on the oxygen supply mode change instruction.

The slag layer refers to an initial liquid phase formed after the scrap steel and the molten iron enter the melting period in the electric arc furnace.

For example, in the early melting stage, the submerged supersonic gas-solid oxygen lance injects the slag-forming material at a low flow rate, which causes iron oxide in the scrap steel and the molten iron to combine with the slag-forming material to form the slag layer. The slag layer floats on a surface of the molten bath. The molten bath refers to an entire liquid region formed by the molten steel or the molten iron and the slag layer.

In some embodiments, in response to determining that a charging of the raw material is completed, the control device may generate a motion control instruction. The control device controls the submerged supersonic gas-solid oxygen lance to extend into the slag layer based on the motion control instruction.

A preset value refers to an oxygen flow rate used to determine whether to change the mode of the submerged supersonic gas-solid oxygen lance to a gas-solid injection mode.

In some embodiments, the preset value may be preset by a technician based on experience.

A gas-solid injection mode refers to a mode for injecting slag-forming material, oxygen, and the fuel gas into the electric arc furnace.

In some embodiments, in the gas-solid injection mode, a flow rate of the slag-forming material in the gas-solid channel of the submerged supersonic gas-solid oxygen lance is 30-200 kg/min, and an oxygen flow rate is 600-3000 m³/h. An oxygen flow rate of the first annular oxygen channel is 10-200 m³/h. A methane flow rate of the annular combustion channel is 20-400 m³/h. An oxygen flow rate of the second annular oxygen channel is 10-200 m³/h.

In some embodiments, the methane flow rate may include 20 m³/h-58 m³/h, 58 m³/h-96 m³/h, 96 m³/h-134 m³/h, 134 m³/h-172 m³/h, 172 m³/h-210 m³/h, 210 m³/h-248 m³/h, 248 m³/h-286 m³/h, 286 m³/h-324 m³/h, 324 m³/h-362 m³/h, and 362 m³/h-400 m³/h. In some embodiments, the methane flow rate may be one or more of 20 m³/h, 58 m³/h, 96 m³/h, 134 m³/h, 172 m³/h, 210 m³/h, 248 m³/h, 286 m³/h, 324 m³/h, 362 m³/h, and 400 m³/h.

It should be noted that the combustion of the methane can compensate for a heat deficit generated by the endothermic dissolution of the slag-forming material. This reduces the temperature fluctuation of the molten bath. Furthermore, the methane can be completely combusted under conditions of excess oxygen, without generating a reduction reaction and without affecting the slagging and dephosphorization.

In some embodiments, the flow rate of the slag-forming material may include 30 kg/min-47 kg/min, 47 kg/min-64 kg/min, 64 kg/min-81 kg/min, 81 kg/min-98 kg/min, 98 kg/min-115 kg/min, 115 kg/min-132 kg/min, 132 kg/min-149 kg/min, 149 kg/min-166 kg/min, 166 kg/min-183 kg/min, and 183 kg/min-200 kg/min. In some embodiments, the flow rate of the slag-forming material may be one or more of 30 kg/min, 47 kg/min, 64 kg/min, 81 kg/min, 98 kg/min, 115 kg/min, 132 kg/min, 149 kg/min, 166 kg/min, 183 kg/min, and 200 kg/min.

In some embodiments, the oxygen flow rate of the first annular oxygen channel and the second annular oxygen channel may include 10 m³/h-29 m³/h, 29 m³/h-48 m³/h, 48 m³/h-67 m³/h, 67 m³/h-86 m³/h, 86 m³/h-105 m³/h, 105 m³/h-124 m³/h, 124 m³/h-143 m³/h, 143 m³/h-162 m³/h, 162 m³/h-181 m³/h, and 181 m³/h-200 m³/h. In some embodiments, the oxygen flow rate of the first annular oxygen channel and the second annular oxygen channel may be one or more of 10 m³/h, 29 m³/h, 48 m³/h, 67 m³/h, 86 m³/h, 105 m³/h, 124 m³/h, 143 m³/h, 162 m³/h, 181 m³/h, and 200 m³/h.

In some embodiments, in response to determining that the oxygen flow rate reaches the preset value, the control device may generate a gas-solid mode change instruction. The control device controls the mode of the submerged supersonic gas-solid oxygen lance to change to the gas-solid injection mode based on the gas-solid mode change instruction.

In 330, in an oxidation and temperature-rising period, and in an early stage of oxidation and temperature rising, the flow rate of the slag-forming material may be maintained at 50-200 kg/min; in a late stage of oxidation and temperature rising, the flow rate of the slag-forming material may be not greater than 50 kg/min; after completion of slagging and dephosphorization, the submerged supersonic gas-solid oxygen lance may be changed to a gas supply mode, and the oxygen flow rate is 1500-2500 m³/h.

The oxidation and temperature-rising period refers to a process of heating, dephosphorizing, desulfurizing, and alloying of the molten steel.

In some embodiments, the oxidation and temperature-rising period may include the early stage of oxidation and temperature rising and the late stage of oxidation and temperature rising.

In some embodiments, the control device may determine whether the steelmaking stage has reached the oxidation and temperature-rising period based on a temperature inside the electric arc furnace and a thickness of the slag layer.

For example, in response to determining that the temperature inside the electric arc furnace is greater than or equal to 1480° C. and the thickness of the slag layer is greater than or equal to 80 mm, the control device may determine that the steelmaking stage has entered the oxidation and temperature-rising period.

In some embodiments, the control device may determine whether the steelmaking stage is the early stage of oxidation and temperature rising or the late stage of oxidation and temperature rising based on the temperature inside the electric arc furnace.

For example, in response to determining that the temperature inside the electric arc furnace is greater than or equal to 1480° C. and less than 1550° C., the control device may determine that a current steelmaking stage is the early stage of oxidation and temperature rising. In response to determining that the temperature inside the electric arc furnace is greater than or equal to 1550° C., the control device may determine that the current steelmaking stage is the late stage of oxidation and temperature rising. In the early stage of oxidation and temperature rising, the control device may maintain the flow rate of the slag-forming material at 50-200 kg/min. In the late stage of oxidation and temperature rising, the control device may maintain the flow rate of the slag-forming material less than or equal to 50 kg/min.

Merely by way of example, the flow rate of the slag-forming material in the early stage of oxidation and temperature rising may include 50 kg/min-65 kg/min, 65 kg/min-80 kg/min, 80 kg/min-95 kg/min, 95 kg/min-110 kg/min, 110 kg/min-125 kg/min, 125 kg/min-140 kg/min, 140 kg/min-155 kg/min, 155 kg/min-170 kg/min, 170 kg/min-185 kg/min, and 185 kg/min-200 kg/min. The flow rate of the slag-forming material in the early stage of oxidation and temperature rising may be one or more of 50 kg/min, 65 kg/min, 80 kg/min, 95 kg/min, 110 kg/min, 125 kg/min, 140 kg/min, 155 kg/min, 170 kg/min, 185 kg/min, and 200 kg/min. The flow rate of the slag-forming material in the late stage of oxidation and temperature rising may include 10 kg/min-20 kg/min, 20 kg/min-30 kg/min, 30 kg/min-40 kg/min, and 40 kg/min-50 kg/min. The flow rate of the slag-forming material in the late stage of oxidation and temperature rising may be one or more of 10 kg/min, 20 kg/min, 30 kg/min, 40 kg/min, and 50 kg/min.

The slagging and dephosphorization refer to an operation of precipitating phosphorus elements in the molten steel by adding the slag-forming material to the electric arc furnace to achieve a dephosphorization effect.

In some embodiments, the control device may add the slag-forming material (e.g., the quicklime powder, the limestone powder, the fluorite powder, the magnesium ball powder, etc.) to the molten bath to form a slag with high basicity and high oxidizability, which causes phosphorus (P) in the molten steel to be oxidized to phosphate (P₂O₅) and enter a slag phase, thereby reducing a phosphorus content in the molten steel.

In some embodiments, the control device may determine whether the electric arc furnace has completed the slagging and dephosphorization in various ways.

For example, the control device may determine a phosphorus content in the molten bath through direct reading spectroscopy of the molten bath. In response to determining that the phosphorus content in the molten bath is less than a phosphorus content threshold, the control device may determine that the slagging and dephosphorization are completed. The phosphorus content threshold may be preset by a technician based on requirements.

The gas supply mode refers to a mode for continuously supplying oxygen to the electric arc furnace for heat preservation and for storing heat for tapping.

In some embodiments, in response to determining that the slagging and dephosphorization are completed, the control device may generate a gas supply mode change instruction and control the submerged supersonic gas-solid oxygen lance to change to the gas supply mode based on the gas supply mode change instruction.

In some embodiments, gases output in the gas supply mode and the oxygen supply mode are both oxygen. In the gas supply mode, the oxygen flow rate is 1500-2500 m³/h. In the oxygen supply mode, the oxygen flow rate is 600-3000 m³/h.

In some embodiments, the oxygen flow rate in the gas supply mode may include 1500 m³/h-1600 m³/h, 1600 m³/h-1700 m³/h, 1700 m³/h-1800 m³/h, 1800 m³/h-1900 m³/h, 1900 m³/h-2000 m³/h, 2000 m³/h-2100 m³/h, 2100 m³/h-2200 m³/h, 2200 m³/h-2300 m³/h, 2300 m³/h-2400 m³/h, and 2400 m³/h-2500 m³/h. In some embodiments, the oxygen flow rate in the gas supply mode may be one or more of 1500 m³/h, 1600 m³/h, 1700 m³/h, 1800 m³/h, 1900 m³/h, 2000 m³/h, 2100 m³/h, 2200 m³/h, 2300 m³/h, 2400 m³/h, and 2500 m³/h.

In 340, in a tapping stage, in response to determining that the temperature of the molten steel rises to an expected temperature, the submerged supersonic gas-solid oxygen lance may be controlled to stop oxygen supply, the protective gas mode may be started, smelting of the molten steel may be completed, and tapping may be performed.

The tapping stage refers to a stage where the molten steel can be discharged after the completion of the slagging and dephosphorization.

In some embodiments, the control device may determine whether the steelmaking stage has entered the tapping stage based on the temperature of the molten steel.

For example, in response to completion of the slagging and dephosphorization in the electric arc furnace, the control device may monitor the temperature of the molten steel inside the electric arc furnace. In response to determining that the temperature of the molten steel is greater than or equal to 1650° C., the control device may determine that the current steelmaking stage has entered the tapping stage.

The expected temperature refers to a temperature of the molten steel used to determine whether the steelmaking stage has entered the tapping stage. For example, the expected temperature may be 1650° C.

In some embodiments, the expected temperature may be preset by a technician based on experience.

In some embodiments, in response to determining that the temperature of the molten steel rises to the expected temperature, the control device may generate a protection mode change instruction, and control the submerged supersonic gas-solid oxygen lance to stop supplying oxygen and to start the protective gas mode based on the protection mode change instruction.

In some embodiments of the present disclosure, supersonic injection of the slag-forming material with 100-400 mesh into the slag layer within the electric arc furnace by the submerged supersonic gas-solid oxygen lance can effectively increase the efficiency of the slagging and dephosphorization and increase utilization rate of the slag-forming material. Simultaneously, rapid slagging of the scrap steel in the gas-solid injection mode and submerged arc formation in the molten bath can reduce arc exposure time and reduce energy consumption. The use of a special lance tip structure including the annular oxygen channels and the annular combustion channel can reduce a surface temperature of the lance tip of the submerged supersonic gas-solid oxygen lance and extend a service life. In different steelmaking stages, injection flow rates of oxygen and the slag-forming material are adjusted according to conditions of the molten bath and the electric arc furnace, which makes the steelmaking process controllable, provides a wider process window and greater operational flexibility, and allows coverage of all working conditions without replacing the submerged supersonic gas-solid oxygen lance.

It should be noted that the foregoing description of process 300 is merely for illustration and explanation and does not limit the applicable scope of the present disclosure. A person skilled in the art can make various modifications and changes to the process 300 under the guidance of the present disclosure. However, these modifications and changes are still within the scope of the present disclosure.

The implementation process of the method for low-slag efficient smelting based on the submerged supersonic gas-solid injection is described below with reference to some specific examples.

### Embodiment 1

The embodiments provide a method for low-slag efficient smelting based on submerged supersonic gas-solid injection. The method uses a system for low-slag efficient smelting based on submerged supersonic gas-solid injection. An electric arc furnace is an electric arc furnace of 75 t. A wear-resistant pipe is configured to connect an outlet of a powder injection device to an oxygen pipeline at a tail end of a supersonic gas-solid oxygen lance, and a gas medium for conveying powder is oxygen. A powder supply pipeline refers to a wear-resistant stainless steel pipe of φ50×5 mm. The powder is directly input into the tail end of the supersonic gas-solid oxygen lance through the powder injection tank. A nozzle of the supersonic gas-solid oxygen lance has a Mach number of 2.1. Oxygen is directly used as a carrier gas for conveying the powder material. An oxygen flow rate is 600-2000 m³/h. A pressure is 0.6-1.5 MPa. A slag-forming material is limestone powder, and a particle size of the slag-forming material is less than 2 mm.

The method includes the following steps:

In a raw material charging period and in a scrap steel and molten iron charging stage, controlling the submerged supersonic gas-solid oxygen lance in a protective gas mode; a carrier gas flow rate for the slag-forming material is 100-3000 m³/h, which prevents splashing during a charging process from clogging a head of the supersonic gas-solid injection lance (also referred to as the supersonic gas-solid oxygen lance, the submerged supersonic gas-solid injection oxygen lance, and the submerged supersonic gas-solid oxygen lance).

In a melting period, in response to determining that charging of raw material is completed, the electrodes start to be powered, and the melting period begins, changing the submerged supersonic gas-solid oxygen lance to an oxygen supply mode; where the submerged supersonic gas-solid oxygen lance is extended into a slag layer, and an oxygen flow rate is 2000 m³/h; in response to determining that the oxygen flow rate reaches a preset value, changing the submerged supersonic gas-solid oxygen lance to a gas-solid injection mode; a flow rate of the slag-forming material of a gas-solid channel is 30-50 kg/min, a oxygen flow rate of the gas-solid channel is 600-2000 m³/h, an oxygen flow rate of a first annular oxygen channel is 10-200 m³/h, a methane flow rate of an annular combustion channel is 20-200 m³/h, and an oxygen flow rate of a second annular oxygen channel is 10-100 m³/h. Meanwhile, some lumpy slag-forming materials may be added through a charging bin according to on-site smelting conditions. In an early melting stage, a low flow rate (a flow rate of slag-forming material of the gas-solid channel is 30 kg/min, an oxygen flow rate is 1000 m³/h, an oxygen flow rate of the first annular oxygen channel is 50 m³/h, a methane flow rate of the annular combustion channel is 100 m³/h, an oxygen flow rate of the second annular oxygen channel is 50 m³/h) is used to spray limestone powder for rapid melting and slagging, reducing a slag volume and shortening a slag formation time. A late melting stage is a main period for dephosphorization. In the late melting stage, a high flow rate (the flow rate of the slag-forming material of the gas-solid channel is 40 kg/min, the oxygen flow rate of the gas-solid channel is 2000 m³/h, the oxygen flow rate of the first annular oxygen channel is 100 m³/h, the methane flow rate of the annular combustion channel is 200 m³/h, the oxygen flow rate of the second annular oxygen channel is 100 m³/h) is used for supersonic gas-solid injection for deep dephosphorization. Some lumpy slag-forming materials are added simultaneously. Compared with lumpy lime, the powder has a larger specific surface area, which maximizes acceleration of metallurgical chemical reactions, reduces a slag volume, and improves a dephosphorization rate. In addition, after adopting the gas-solid injection mode of the submerged supersonic gas-solid oxygen lance, a jet length is increased, and a jet impact force is enhanced, thereby strengthening a stirring effect on the molten bath.

In an oxidation and temperature-rising period, and in an early stage of oxidation and temperature rising, maintaining the flow rate (the flow rate of the slag-forming material of the gas-solid channel is 50 kg/min, the oxygen flow rate is 2000 m³/h, the oxygen flow rate of the first annular oxygen channel is 100 m³/h, the methane flow rate of the annular combustion channel is 200 m³/h, the oxygen flow rate of the second annular oxygen channel is 100 m³/h) for injection. Meanwhile, slag-forming materials such as lime lumps, magnesium balls, slag fluxing agents, and fluorite are added to continue deep dephosphorization. After entering a late stage of oxidation and temperature rising, dephosphorization reactions are few or no longer occur at this time. The slag mainly serves a function of submerged arc heat preservation. In this stage, a powder injection flow rate of the submerged supersonic gas-solid oxygen lance may be appropriately reduced. The flow rate may be controlled at 30 kg/min. Meanwhile, some lumpy slag-forming materials are added according to smelting conditions. After the slagging and dephosphorization stage is completed, the gas-solid injection mode of the submerged supersonic gas-solid oxygen lance is turned off, and the powder injection tank stops feeding powder. The submerged supersonic gas-solid injection oxygen lance is in a gas supply mode, the oxygen flow rate of the gas-solid channel is 2000 m³/h, the flow rate of the first annular oxygen channel is 100 m³/h, a flow rate of the annular combustion channel is 200 m³/h, a flow rate of the second annular oxygen channel is 100 m³/h.

In a tapping stage, in response to determining that a temperature of the molten steel rises to an expected temperature, controlling the submerged supersonic gas-solid oxygen lance to stop oxygen supply and start the protective gas mode, completing smelting of the molten steel, and performing tapping.

Experimental results show that: for steelmaking of the electric arc furnace of 75 t, compared with a traditional electric arc furnace top-added slag-forming material dephosphorization process, using the submerged supersonic gas-solid injection limestone powder, the low-slag efficient dephosphorization process increases a dephosphorization rate by 2.5%, reduces the slag volume by 10 kg/t, reduces consumption of the limestone powder by 3%, and increases a metal yield by 1%.

### Embodiment 2

The embodiments provide a method for low-slag efficient smelting based on submerged supersonic gas-solid injection. The method uses a system for low-slag efficient smelting based on submerged supersonic gas-solid injection. An electric arc furnace is an electric arc furnace of 115 t. A powder supply pipeline uses a wear-resistant stainless steel pipe of φ50×5 mm. The powder is directly input into a tail end of a supersonic gas-solid injection oxygen lance through a powder injection tank. A nozzle of the supersonic gas-solid injection oxygen lance has a Mach number of 2.1. Oxygen is directly used as a carrier gas for conveying the powder material. An oxygen flow rate is 2500 m³/h. A pressure is 0.6-1.5 MPa. A slag-forming material is limestone powder, and a particle size of the slag-forming material is less than 2 mm.

The method includes the following steps:

In a raw material charging period and in a scrap steel and molten iron charging stage, controlling the submerged supersonic gas-solid oxygen lance in a protective gas mode; an oxygen flow rate is 30 m³/h, which prevents splashing during a charging process from clogging a head of the supersonic gas-solid injection lance.

In a melting period, in response to determining that charging of raw material is completed, the electrodes start to be powered, and the melting period begins, changing the submerged supersonic gas-solid oxygen lance to an oxygen supply mode; where the submerged supersonic gas-solid oxygen lance is extended into a slag layer, and an oxygen flow rate is 2500 m³/h; in response to determining that the oxygen flow rate reaches a preset value, starting feeding by controlling a powder injection system of the powder injection tank, changing the submerged supersonic gas-solid oxygen lance to a gas-solid injection mode; a flow rate of slag-forming material of a gas-solid channel is 35-50 kg/min, an oxygen flow rate of the gas-solid channel is 600-2500 m³/h, an oxygen flow rate of a first annular oxygen channel is 10-125 m³/h, a methane flow rate of an annular combustion channel is 20-250 m³/h, and an oxygen flow rate of a second annular oxygen channel is 10-125 m³/h. Meanwhile, some lumpy slag-forming materials may be added through a charging bin according to on-site smelting conditions. In an early melting stage, a low flow rate (the flow rate of the slag-forming material of the gas-solid channel is 40 kg/min, the oxygen flow rate of the gas-solid channel is 1000 m³/h, the oxygen flow rate of the first annular oxygen channel is 50 m³/h, the methane flow rate of the annular combustion channel is 100 m³/h, the oxygen flow rate of the second annular oxygen channel is 50 m³/h) is used to spray limestone powder for rapid melting and slagging, reducing a slag volume and shortening a slag formation time. A late melting stage is a main period for dephosphorization. In the late melting stage, a high flow rate (the flow rate of the slag-forming material of the gas-solid channel is 50 kg/min, the oxygen flow rate of the gas-solid channel is 2500 m³/h, the oxygen flow rate of the first annular oxygen channel is 125 m³/h, the methane flow rate of the annular combustion channel is 250 m³/h, the oxygen flow rate of the second annular oxygen channel is 125 m³/h) is used for supersonic gas-solid injection for deep dephosphorization. Some lumpy slag-forming materials are added simultaneously. Compared with lumpy lime, the powder has a larger specific surface area, which maximizes acceleration of metallurgical chemical reactions, reduces a slag volume, and improves a dephosphorization rate. In addition, after adopting the gas-solid injection mode of the submerged supersonic gas-solid oxygen lance, a jet length is increased, and a jet impact force is enhanced, thereby strengthening a stirring effect on the molten bath.

In an oxidation and temperature-rising period, and in an early stage of oxidation and temperature rising, maintaining the flow rate (the flow rate of the slag-forming material of the gas-solid channel is 60 kg/min, the oxygen flow rate of the gas-solid channel is 2500 m³/h, the oxygen flow rate of the first annular oxygen channel is 125 m³/h, the methane flow rate of the annular combustion channel is 250 m³/h, the oxygen flow rate of the second annular oxygen channel is 125 m³/h) for injection. Meanwhile, slag-forming materials such as lime lumps, magnesium balls, slag fluxing agents, and fluorite are added to continue deep dephosphorization. After entering a late stage of oxidation and temperature rising, dephosphorization reactions are few or no longer occur at this time. The slag mainly serves a function of submerged arc heat preservation. In this stage, a powder injection flow rate of the submerged supersonic gas-solid oxygen lance may be appropriately reduced. The flow rate may be controlled at 40 kg/min. Meanwhile, some lumpy slag-forming materials are added according to smelting conditions. After the slagging and dephosphorization stage is completed, the gas-solid injection mode of the submerged supersonic gas-solid oxygen lance is turned off, and the powder injection tank stops feeding powder. The submerged supersonic gas-solid injection oxygen lance is in a gas supply mode, the oxygen flow rate of the gas-solid channel is 2500 m³/h, the flow rate of the first annular oxygen channel is 125 m³/h, a flow rate of the annular combustion channel is 250 m³/h, a flow rate of the second annular oxygen channel is 125 m³/h.

In a tapping stage, in response to determining that a temperature of the molten steel rises to an expected temperature, controlling the submerged supersonic gas-solid oxygen lance to stop oxygen supply and start the protective gas mode, completing smelting of the molten steel, and performing tapping.

Experimental results show that: for steelmaking of the electric arc furnace of 115 t, compared with a traditional electric arc furnace top-added slag-forming material dephosphorization process, using the submerged supersonic gas-solid injection limestone powder, the low-slag efficient dephosphorization process increases a dephosphorization rate by 3%, reduces the slag volume by 15 kg/t, reduces consumption of the limestone powder by 5%, and increases a metal yield by 1%.

### Comparative Embodiment 1

In a steelmaking process of an electric arc furnace, a method of adding lumpy lime is generally used for dephosphorization. Lumpy lime is usually added in two batches. Taking a shaft-type electric arc furnace as an example, a first batch of slag-forming material is added after a third batch of scrap steel is added to a molten bath. The lumpy lime is added through a charging bin, and an addition amount is 3 t. A second batch of slag-forming material is added after a last batch of scrap steel is added to the molten bath. The lumpy lime is added through a charging bin, and an addition amount is 0.7 t. In this process, the lumpy lime needs to melt first in the molten bath before participating in the dephosphorization reaction, resulting in a low dephosphorization efficiency. Taking an ordinary electric arc furnace of 90 t as another example, a straight pipe lance is used to spray limestone powder to improve the dephosphorization efficiency. A limestone powder injection dephosphorization process is as follows: a full-process limestone powder injection rate is 45 kg/min, and an injection time is 35 min. Some slag-forming materials are added in a lumpy form. A weight of the lumpy lime is 1.3 t. Compared with using only lumpy slag-forming materials for dephosphorization, this process increases the dephosphorization rate by 1.2%. Although using the straight pipe lance can improve the dephosphorization efficiency, the dephosphorization efficiency can be further improved by changing a structure of the lance. In some embodiments of the present disclosure, the submerged supersonic gas-solid oxygen lance can increase the dephosphorization efficiency by 2.5-5%.

In some embodiments of the present disclosure, an original injection method for slag-forming material and a nozzle structure are changed to provide a supersonic limestone powder injection solution and a supersonic gas-solid injection lance structure. By changing injection parameters of the supersonic gas-solid injection lance during the smelting process, different injection modes are regulated according to smelting characteristics of different stages to adapt to dephosphorization requirements of each stage, achieving low-slag efficient smelting in the electric arc furnace.

### Comparative Embodiment 2

This embodiment is a comparison with EMBODIMENT 1. The difference from EMBODIMENT 1 lies in different injection parameters. The electric arc furnace is an electric arc furnace of 75 t. A structure of a head of the submerged supersonic gas-solid oxygen lance is the same as that in EMBODIMENT 1. Oxygen is directly used as a carrier gas for conveying the powder material. An oxygen flow rate is 600-2000 m³/h. A pressure is 0.6-1.5 MPa. A slag-forming material is limestone powder. A particle size of the limestone powder is less than 2 mm.

The process includes the following steps:

In a raw material charging period and in a scrap steel and molten iron charging stage, controlling the submerged supersonic gas-solid oxygen lance in a protective gas mode; a carrier gas flow rate for the slag-forming material is 30 m³/h, which prevents splashing during a charging process from clogging the head of the supersonic gas-solid injection lance.

In a melting period, in response to determining that charging of raw material is completed, the electrodes start to be powered, and the melting period begins, changing the submerged supersonic gas-solid oxygen lance to an oxygen supply mode; the submerged supersonic gas-solid oxygen lance is extended into a slag layer, and an oxygen flow rate is 2000 m³/h; in response to determining that the oxygen flow rate reaches a preset value, changing the submerged supersonic gas-solid oxygen lance to a gas-solid injection mode; a flow rate of slag-forming material of a gas-solid channel is 10-25 kg/min, an oxygen flow rate of the gas-solid channel is 600-2000 m³/h, an oxygen flow rate of a first annular oxygen channel is 10-200 m³/h, a methane flow rate of an annular combustion channel is 20-200 m³/h, and an oxygen flow rate of a second annular oxygen channel is 10-100 m³/h. Meanwhile, some lumpy slag-forming materials may be added through a charging bin according to on-site smelting conditions. In an early melting stage, a low flow rate (the flow rate of the slag-forming material of the gas-solid channel is 10-15 kg/min, the oxygen flow rate of the gas-solid channel is 1000 m³/h, the oxygen flow rate of the first annular oxygen channel is 50 m³/h, the methane flow rate of the annular combustion channel is 100 m³/h, the oxygen flow rate of the second annular oxygen channel is 50 m³/h) is used to spray limestone powder for rapid melting and slagging, reducing a slag volume and shortening a slag formation time. A late melting stage is a main period for dephosphorization. In the late melting stage, a high flow rate (the flow rate of the slag-forming material of the gas-solid channel is 20 kg/min, the oxygen flow rate of the gas-solid channel is 2000 m³/h, the oxygen flow rate of the first annular oxygen channel is 100 m³/h, the methane flow rate of the annular combustion channel is 200 m³/h, the oxygen flow rate of the second annular oxygen channel is 100 m³/h) is used for this stage.

In an oxidation and temperature-rising period, and in an early stage of oxidation and temperature rising, maintaining the flow rate (the flow rate of the slag-forming material of the gas-solid channel is 25 kg/min, the oxygen flow rate of the gas-solid channel is 2000 m³/h, the oxygen flow rate of the first annular oxygen channel is 100 m³/h, the methane flow rate of the annular combustion channel is 200 m³/h, the oxygen flow rate of the second annular oxygen channel is 100 m³/h) for injection. Meanwhile, slag-forming materials such as lime lumps, magnesium balls, slag fluxing agents, and fluorite are added to continue deep dephosphorization. After entering a late stage of oxidation and temperature rising, dephosphorization reactions are few or no longer occur at this time. The slag mainly serves a function of submerged arc heat preservation. In this stage, a powder injection flow rate of the submerged supersonic gas-solid oxygen lance may be appropriately reduced. The flow rate may be controlled at 10-15 kg/min. Meanwhile, some lumpy slag-forming materials are added according to smelting conditions. After the slagging and dephosphorization stage is completed, the gas-solid injection mode of the submerged supersonic gas-solid oxygen lance is turned off, and the powder injection tank stops feeding powder. The submerged supersonic gas-solid injection oxygen lance is in a gas supply mode, the oxygen flow rate of the gas-solid channel is 2000 m³/h, the flow rate of the first annular oxygen channel is 100 m³/h, a flow rate of the annular combustion channel is 200 m³/h, a flow rate of the second annular oxygen channel is 100 m³/h.

In a tapping stage, in response to determining that a temperature of the molten steel rises to an expected temperature, controlling the submerged supersonic gas-solid oxygen lance to stop oxygen supply and start the protective gas mode, completing smelting of the molten steel, and performing tapping.

Experimental results show that: for steelmaking of the electric arc furnace of 75 t, compared to the traditional electric arc furnace top-added slagging material dephosphorization process, using submerged supersonic gas-solid blowing limestone powder, the low-slag high-efficiency dephosphorization process does not improve the dephosphorization rate, and even in some of the furnaces dephosphorization effect has become poorer, slag volume did not change significantly, lime powder consumption is slightly reduced, the metal yield is basically unchanged. When using an identical injection method, different injection schemes need to be formulated according to smelting characteristics of the electric arc furnace to better leverage advantages of the supersonic gas-solid injection oxygen lance. However, more importantly, the volume of the injected quicklime powder needs to reach a certain flow rate. Within a suitable range, a larger relative flow rate results in a more pronounced impact effect of a gas-solid jet on the molten bath, thus improving kinetic conditions of the molten bath and demonstrating a better dephosphorization effect.

In closing, it is to be understood that the foregoing embodiments are merely used to illustrate a technical solution of the present disclosure and are not intended to limit the present disclosure. Although the present disclosure has been described in detail with reference to the foregoing embodiments, a person of ordinary skill in the art should understand that modifications may still be made to a technical solution described in the foregoing embodiments, or equivalent substitutions may be made to some or all technical features therein. These modifications or substitutions do not cause an essence of a corresponding technical solution to depart from the scope of a technical solution of embodiments of the present disclosure.

What is claimed is:

1. A method for low-slag efficient smelting based on submerged supersonic gas-solid injection, comprising:
in a raw material charging period, and in a scrap steel and molten iron charging stage, controlling a submerged supersonic gas-solid oxygen lance in a protective gas mode, wherein a protective gas flow rate is 10-200 m³/h;
in a melting period, in response to determining that charging of raw material is completed, changing the submerged supersonic gas-solid oxygen lance to an oxygen supply mode, wherein the submerged supersonic gas-solid oxygen lance is extended into a slag layer, and an oxygen flow rate is 600-3000 m³/h; in response to determining that the oxygen flow rate reaches a preset value, changing the submerged supersonic gas-solid oxygen lance to a gas-solid injection mode, wherein an outlet of the submerged supersonic gas-solid oxygen lance includes, from inside to outside, a gas-solid channel, a first annular oxygen channel, an annular combustion channel, and a second annular oxygen channel, a flow rate of slag-forming material of the gas-solid channel is 30-200 kg/min, the oxygen flow rate is 600-3000 m³/h, the oxygen flow rate of the first annular oxygen channel is 10-200 m³/h, a methane flow rate of the annular combustion channel is 20-400 m³/h, and the oxygen flow rate of the second annular oxygen channel is 10-200 m³/h;
in an oxidation and temperature-rising period, and in an early stage of oxidation and temperature rising, maintaining the flow rate of the slag-forming material at 50-200 kg/min; in a late stage of oxidation and temperature rising, controlling the flow rate of the slag-forming material to be not greater than 50 kg/min; after completion of slagging and dephosphorization, changing the submerged supersonic gas-solid oxygen lance to a gas supply mode, wherein the oxygen flow rate is 1500-2500 m³/h;
in a tapping stage, in response to determining that a temperature of molten steel rises to an expected temperature, controlling the submerged supersonic gas-solid oxygen lance to stop oxygen supply and start the protective gas mode, completing smelting of the molten steel, and performing tapping.

2. The method according to claim 1, wherein an oxygen pressure of the submerged supersonic gas-solid oxygen lance is 0.5-1.6 MPa.

3. The method according to claim 1, wherein the slag-forming material includes at least one of quicklime powder, limestone powder, fluorite powder, or magnesium ball powder.

4. The method according to claim 3, wherein a particle size of the slag-forming material is 100-400 mesh.

5. The method according to claim 1, further comprising: adding lumpy slag-forming material during the melting period and the oxidation and temperature-rising period.

6. The method according to claim 1, wherein a carrier gas flow rate for the slag-forming material is 100-3000 m³/h.

7. The method according to claim 1, wherein the protective gas includes at least one of nitrogen or carbon dioxide.
